(19) United States
(12) Patent Application Publication
(10) Pub. No.: US 2008/0247606 A1
(43) Pub. Date: Oct. 9, 2008

(54) Agile illumination for biometric authentication

(75) Inventor: Jan Jelinek, Plymouth, MN (US)

Correspondence Address: Kris T. Fredrick;Honeywell International Inc., 101 Columbia Rd., P.O. Box 2245, Morristown, NJ, 07962, US

(73) Assignee: Honeywell International Inc.

(21) Appl. No.: 11/732,590

(22) Filed: Apr. 3, 2007

(51) Int. Cl. G06K 9/00

(52) U.S. Cl. 382/115

(57) ABSTRACT

An agile illumination apparatus for use in biometric authentication is disclosed. A controlled spot flash strobe forms and focuses a narrow illuminating beam so as to cover an area of interest for a biometric authentication of a target with a spot of light of constant size regardless of a distance of the target from the controlled spot flash strobe. A positioner can then be utilized to steer the narrow illuminating beam to a target in a monitored space. The spot size is kept constant and its irradiance distribution is kept uniform in order to deliver a constant amount of energy to the target irrespective of the distance, wherein the controlled spot flash strobe automatically reduces its power as the target moves closer to the controlled spot flash strobe in order to maintain a constant exposure value and provide for enhanced biometric authentication of the target.

### TECHNICAL FIELD

Embodiments are generally related to biometric security applications. Embodiments are also related to strobe devices and related optical systems, devices and methods. Embodiments are additionally related to photographic flash devices and techniques.

### BACKGROUND OF THE INVENTION

Security for electronic and mechanical systems has rapidly become an important issue in recent years. With the proliferation of computers, computer networks and other electronic device and networks into all aspects of business and daily life, the concern over secure file and transaction access has grown tremendously. The ability to secure data and transactions is particularly important for financial, medical, education, government, military, and communications endeavors. In addition, there is also a continuing to need to permit access to secure facilities in both private and public facilities, buildings, and compounds.

Biometric access control systems have been developed to authorize accesses to various electronic and mechanical systems. Biometrics can generally be defined as the science of utilizing unique physical or behavioral personal characteristics to verify the identity of an individual. Biometric authentication systems are typically combined with hardware and software systems for automated biometric verification or identification. Biometric authentication systems receive a biometric input, such as a fingerprint or a voice sample, from a user. This biometric input is typically compared against a prerecorded template containing biometric data associated with the user to determine whether to grant the user access to a service on the host system.

While such biometric access control systems represent a large segment of applications, they generally do not require flash strobes, because identification is either based on direct physical contact or is done at a very short distance, where continuous light sources suffice. The technology discussed herein has emerged during the development of what is sometimes referred to as biometric identity management systems. Such systems are envisioned to be used, for example, to identify people in airport departure halls, boarding or leaving aircraft trough a jet way, waiting in security checkpoint lines, loitering around government buildings, watching military convoys from sidewalks, etc.

The key difference between these types of systems is that identification is accomplished at a relatively large distance, without physically contacting the target, who is allowed to move freely about her business, without being forced to pass through an obstructing checkpoint. Since human irises (and faces) are optically diffusive (i.e., not mirror-like) targets, the amount of light they send toward to the camera drops with the square of their distance from it. This means that at a large distance, the iris must be illuminated by a huge amount of light to get a strong enough bounce needed for safe identification, especially for fast moving persons.

One non-limiting example of a facial biometric authentication technique is disclosed in U.S. Patent Application Publication No. 20040240711, entitled “Face Identification Verification Using 3 dimensional Modeling,” which published on Dec. 2, 2004 to Rida Hamza et al., and is assigned to Honeywell International Inc. Note that U.S. Patent Application Publication No. 20040240711 is incorporated herein by reference in its entirety. An example of an iris biometric authentication system and method is disclosed in U.S. Patent Application Publication No. 20060165266,. entitled “Iris Recognition System and Method,” which published on Jul. 27, 2006 to Rida Hamza and is also assigned to Honeywell International Inc. U.S. Patent Application Publication No. 20060165266 is incorporated herein by reference in its entirety.

Facial and/or iris illumination in the context of biometric authentication systems and devices represents a growing area In biometric security applications, for example, pictures of subjects' faces and irises are often taken at a rate close to one frame per second, and twenty-four hours a day. To obtain a good picture quality, ambient illumination is usually not sufficient, because the target distance may be too large and/or their motion too fast to achieve their sufficient illumination merely by increasing the overall ambient level. In addition, pictures are often taken in infrared spectral region, in which ambient visible light sources do not emit enough radiation and special flood illuminators are both too bulky and heat producing.

A common approach in photography to solve this problem is to use a flash strobe that briefly floods the monitored area with a very bright flash of light during which the picture is exposed. The flood flash illuminates not only the target, whose face or iris represents a tiny portion of the monitored area, but the area as a whole. Even though a single flash exposure may be harmless, a repeated exposure may harm the eyes of the security personnel or other people who may be loitering in the monitored area for extended periods of time.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for improved biometric security applications.

It is another aspect of the present invention to provide for improved strobe devices and related optical systems for use in biometric authentication.

It is a further aspect of the present invention to provide for an agile illumination apparatus for use in a biometric authentication system.

The aforementioned aspects and other objectives and advantages can now be achieved as described herein. An agile illumination apparatus, system and method for use in biometric authentication is disclosed. A controlled spot flash strobe forms a narrow illuminating beam to cover an area of interest for a biometric authentication of a target regardless of a distance of the target from the controlled spot flash strobe. A positioner can then be utilized to steer the narrow illuminating beam to a target in a monitored space with respect to the target in order to actively maintain a size of the narrow illuminating beam and thereby deliver a constant amount of energy to the target irrespective of the distance, wherein the controlled spot flash strobe automatically reduces its power as the target moves closer to the controlled spot flash strobe in order to maintain a constant exposure value and provide for enhanced biometric authentication of the target.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a biometric authentication system, which can be implemented in accordance with an alternative embodiment;

FIG. 2 illustrates a block diagram of a biometric authentication system, which can be implemented in accordance with an alternative embodiment;

FIG. 3 illustrates a block diagram of a biometric authentication system, which can be implemented in accordance with a preferred embodiment; and

FIG. 4 illustrates a block diagram of an agile illumination apparatus, which can be implemented in accordance with a preferred embodiment.

### DETAILED DESCRIPTION

The particular values and configurations discussed in these non-limiting examples can be varied and are cited merely to illustrate at least one embodiment and are not intended to limit the scope thereof.

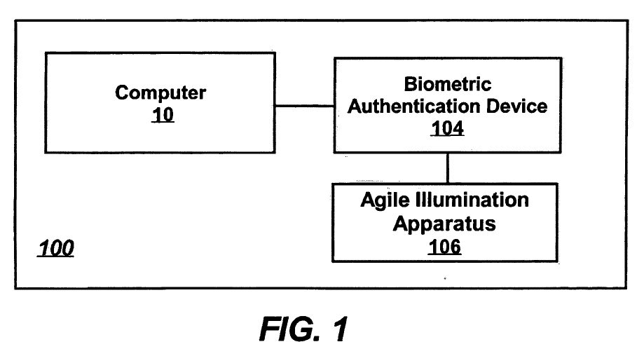

FIG. 1 illustrates a block diagram of a biometric authentication system 100, which can be implemented in accordance with an alternative embodiment. Note that in FIGS. 1-4, identical or similar parts or elements are generally indicated by identical reference numerals. System 100 includes the use of a computer 10, which can communicate with a biometric authentication device 104, which in turn communicates electrically with an agile illumination apparatus 106 that will be described in greater detail herein. Note that as utilized herein the term “computer” refers generally to any machine for manipulating data according to a list of instructions. Computer 10 can be implemented as, for example, personal computers and their portable equivalent, the laptop computer.

Computer 10 may also be implemented as an embedded computer, which is a small, simple device that is often utilized to control other devices, for example. Such embedded computers are found in machines ranging from fighter aircraft to industrial robots, digital cameras, and so forth. Computer 10 can thus be implemented with a capability and complexity ranging from that, for example, of a personal digital assistant to that of a supercomputer. It is also important to note that although a single block labeled “computer 10” is depicted and described herein, embodiments can be equally implemented, which include the use of more than one computer 10 or a group of networked computers, depending upon design considerations. The disclosed embodiments are thus not limited to the use of a single computer 10, but can use multiple, and preferably networked computers.

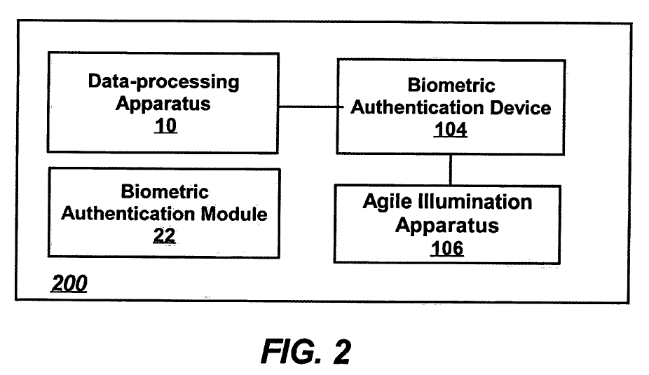

FIG. 2 illustrates a block diagram of a biometric authentication system 200, which can be implemented in accordance with an alternative embodiment. System 200 is similar to that of system 100, but incorporates the use of a biometric authentication module 104. The computer 10 can store and/or process the biometric authentication module 104. The module 104 can be stored in a memory (not shown) of the computer 10 or another similar computing device and then processed via a processing device such as a processor (e.g., a microprocessor) to control the biometric authentication device 104 and its associated agile illumination apparatus 106. Module 104 can be implemented, for example, as a software module that provides instructions that can be processed by computer 10. Module 104 can thus be implemented as a software entity that groups a set of (typically cohesive) subprograms and data structures. The biometric authentication device 104 is thus a process that offers a certain, well-defined functionality that can run on a suitable computing platform.

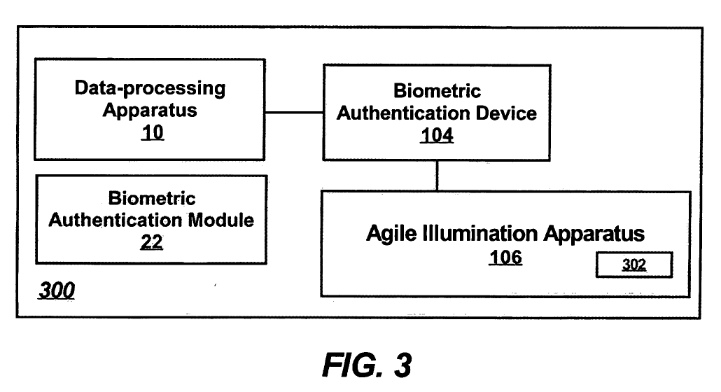

FIG. 3 illustrates a block diagram of a biometric authentication system 300, which can be implemented in accordance with a preferred embodiment. System 300 is similar to that of system 200, but includes the use of a positioning device 302, which forms a part of the agile illumination apparatus 106. The positioning device 302 can be, for example, a pan-tilt-zoom positioner.

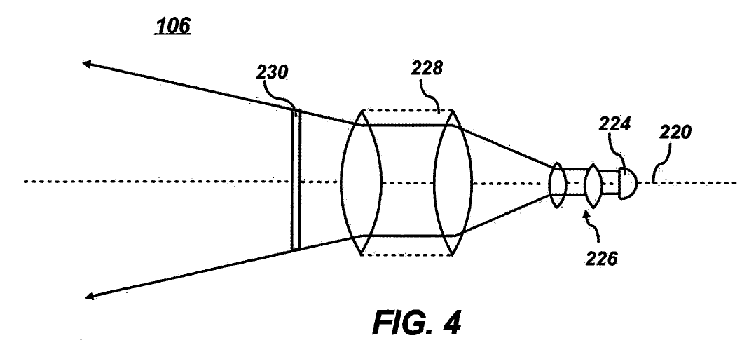

FIG. 4 illustrates a block diagram of an agile illumination apparatus 106, which can be implemented in accordance with a preferred embodiment. The agile illumination apparatus 106 can function as a controlled spot flash strobe that forms a narrow illuminating beam to cover an area of interest for the biometric authentication of a target regardless of a distance of the target from the controlled spot flash probe (i.e., agile illumination apparatus 106). The positioning device 302 can be utilized to steer the narrow illuminating beam so that it points at the desired target in a monitored space. Based on the target distance, the apparatus 106 automatically adjusts the zoom and focus of its optics 228 so as to keep the size of the illuminated spot constant and the target irradiance uniform and thereby deliver a constant amount of energy to the target irrespective of the distance. The target may be, for example, the person or his or her face or iris or whatever object is desired to be photographed and needs to be illuminated by a flash. The controlled spot flash strobe or agile illumination apparatus 106 automatically reduces its power as the target moves closer to the controlled spot flash strobe in order to maintain a constant exposure value and provide for enhanced biometric authentication of the target.

The target (e.g., face or iris) generally functions as a diffuse reflector. Note, however, that a diffusive target is not the same component as the diffuser 224. The “target” as utilized herein is the object being illuminated, such as, for example, a person, and/or his or her face and/or iris. The target depends, of course, on what the biometric system is photographing. Such targets can be said to generally behave like diffuse reflectors (as opposed to specular reflectors, otherwise known as mirrors), but are not in and of themselves “diffusers”. The diffuser 224 is actually an optical device, similar to that of a miniature lens or grated glass plate, which can be inserted in front of the light source 220 within a flash assembly.

In one embodiment, the agile illumination apparatus 106 generally includes a light source 220 that generates light. The diffuser 224 can be located proximate to the light source 220. Additionally, a concentrator 226 is generally located proximate to the diffuser 224. A lens 228 is in turn located proximate to the concentrator 226. A filter 230 can be located proximate to the lens 228, whereby light generated by the light source 220 passes through the diffuser 224, the concentrator 226, the lens 228 and the filter 230 to provide the narrow illuminating beam for biometric authentication of the target.

The diffuser 224 generally collects the light from the light source 220 and uniformly spreads the light over a small area. The concentrator 226 than projects the light into a focal plane of the zoom lens 228, which permits the small area to be projected with the desired size and focused onto the target. Upon exiting the lens 228, the light passes through the filter 230, which blocks off an undesired portion of the light spectrum to thereby provide the narrow illuminating beam for biometric authentication of the target. Note that the filter 230 preferably constitutes a suitable bandpass filter.

Based on the foregoing, it can be appreciated that the agile illumination apparatus 106 can function as a controlled spot flash strobe, which uses optics to form a narrow illuminating beam and make it cover just the area of interest such as, for example, the face or eyes of a human, regardless of the target's distance. The flash can be mounted on the positioning device 302 (e.g., pan-tilt positioner), which steers the beam to the selected point in the monitored space. Actively maintaining the spot size means that the flash delivers to the target a constant amount of energy irrespective of its distance. The target(s) generally are diffuse reflectors, however, and thus the bounced light will suffer energy loss proportional to the squared distance as it travels back toward the camera (not shown). To compensate for this energy variation and maintain a constant exposure value, the flash automatically reduces its power as the targets get closer and vice versa.

The flash feature functions in a manner similar to that of a photographic camera in reverse. The light source 220, be it a flash bulb, laser diode, LED (Light Emitting Diode) or any other source, can be collected by the diffuser 224 and uniformly spread over a small area, which the concentrator 226 projects (approximately) into the focal plane of the zoom lens 228. The lens's zoom and focus can be designed and configured so that the small area is projected onto the target and attains its desired shape (e.g., the desired diameter for circular spots) and focus on the target.

On exiting the lens 228, the beam passes through the bandpass filter 230 that blocks off those parts of the emitted light that are not desired. The filter 230 cutoffs are preferably between at 800 and 1000 nm. It can be appreciated, however, that these parameters are merely suggestions and do not constitute limiting feature of the disclosed embodiments. The zoom and focus of the lens 228 are adjusted by motorized drives, whose associated controllers derive their set points from the target distance measurements. The controllers may be running on a computer, such as computer 10, which also can provide the distance measurements utilizing other sensors associated sensors (not shown).

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An agile illumination apparatus for use in biometric authentication, comprising:
a controlled spot flash strobe that forms a narrow illuminating beam focused on an area of interest for a biometric authentication of a target in a monitored space, and maintains a resulting illuminated spot size and a uniform irradiance across said area of interest regardless of a distance of said target from said controlled spot flash strobe in order to deliver a constant amount of energy to said target irrespective of said distance, wherein said controlled spot flash strobe automatically reduces its power as said target moves closer to said controlled spot flash strobe in order to maintain a constant exposure value and provide for enhanced biometric authentication of said target.

2. The apparatus of claim 1 further comprising:
a positioner that steers said narrow illuminating beam to point at said target in said monitored space.

3. The apparatus of claim 1 wherein said controlled spot flash strobe further comprises:
a light source that generates light;
a diffuser located proximate to said light source;
a concentrator located proximate to said diffuser;
a lens located proximate to said concentrator; and
a filter located proximate to said lens, whereby light generated by said light source passes through said diffuser, said concentrator, said lens and said filter to provide said narrow illuminating beam for biometric authentication of said target.

4. The apparatus of claim 3 wherein:
said diffuser collects said light from said light source and uniformly spreads said light over a small area
said concentrator that projects said light into a focal plane of said lens, such that a zoom of said lens and a focus thereof permit said small area to be projected onto said target with a desired shape and focus; and
wherein upon exiting said lens, said light passes through said filter, which blocks off an undesired portion of said light to thereby provide said narrow illuminating beam for biometric authentication of said target.

5. The apparatus of claim 3 wherein said light source comprises a flash bulb.

6. The apparatus of claim 3 wherein said light source comprises a laser diode.

7. The apparatus of claim 3 wherein said light source comprises an LED.

8. The apparatus of claim 3 wherein said filter comprises a bandpass filter.

9. The apparatus of claim 8 wherein said bandpass filter comprises a highpass filter.

10. The apparatus of claim 3 wherein said zoom and said focus of said lens are adjusted by at least one motorized drive having at least one controller that derive a set point from a measurement of said distance to said target and Wherein said distance controls a flash power of said light source.

11. A biometric authentication system, comprising:
a controlled spot flash strobe that forms a narrow illuminating beam focused on an area of interest for a biometric authentication of a target in a monitored space, and maintains a resulting illuminated spot size and a uniform irradiance across said area of interest regardless of a distance of said target from said controlled spot flash strobe in order to deliver a constant amount of energy to said target irrespective of said distance, wherein said controlled spot flash strobe automatically reduces its power as said target moves closer to said controlled spot flash strobe in order to maintain a constant exposure value and provide for enhanced biometric authentication of said target; and
a positioner that steers said narrow illuminating beam to point at said target in said monitored space;
a light source that generates light;
a diffuser located proximate to said light source;
a concentrator located proximate to said diffuser;
a lens located proximate to said concentrator; and
a filter located proximate to said lens, whereby light generated by said light source passes through said diffuser, said concentrator, said lens and said filter to provide said narrow illuminating beam for biometric authentication of said target.

12. The system of claim 11 wherein:
said diffuser collects said light from said light source and uniformly spreads said light over a small area said concentrator that projects said light into a focal plane of said lens, such that a zoom of said lens and a focus thereof permit said small area to be projected onto said target with a desired shape and focus; and
wherein upon exiting said lens, said light passes through said filter, which blocks off an undesired portion of said light to thereby provide said narrow illuminating beam with a desired spectral distribution for biometric authentication of said target.

13. The system of claim 11 wherein said light source comprises a flash bulb.

14. The system of claim 10 wherein said light source comprises a laser diode.

15. The system of claim 10 wherein said light source comprises an LED.

16. The system of claim 10 wherein said filter comprises a highpass filter.

17. An agile illumination method for use in biometric authentication, said method comprising:
forming a narrow illuminating beam utilizing a controlled spot flash strobe; and
focusing said narrow illuminating beam on an area of interest for a biometric authentication of a target in a monitored space, and maintains a resulting illuminated spot size and a uniform irradiance across said area of interest regardless of a distance of said target from said controlled spot flash strobe in order to deliver a constant amount of energy to said target irrespective of said distance, wherein said controlled spot flash strobe automatically reduces its power as said target moves closer to said controlled spot flash strobe in order to maintain a constant exposure value and provide for enhanced biometric authentication of said target.

18. The method of claim 17 further comprising:
utilizing a positioner to steer said narrow illuminating beam to point at said target in said monitored space.

19. The method of claim 17 further comprising configuring said controlled spot flash strobe to comprise:
a light source that generates light;
a diffuser located proximate to said light source;
a concentrator located proximate to said diffuser;
a lens located proximate to said concentrator; and
a filter located proximate to said lens, whereby light generated by said light source passes through said diffuser, said concentrator, said lens and said filter to provide said narrow illuminating beam for biometric authentication of said target.

20. The method of claim 19 wherein:
said diffuser collects said light from said light source and uniformly spreads said light over a small area
said concentrator that projects said light into a focal plane of said lens, such that a zoom of said lens and a focus thereof permit said small area to be projected onto said target with a desired shape and focus; and
wherein upon exiting said lens, said light passes through said filter, which blocks off an undesired portion of said light to thereby provide said narrow illuminating beam for biometric authentication of said target.
